(19) United States
(12) Patent Application Publication
(10) Pub. No.: US 2005/0090301 A1
(43) Pub. Date: Apr. 28, 2005

(54) Holder for an electronic device

(76) Inventors: Thorsten Lange, Mindelheim (DE); Frank Templin, Munchen (DE)

Correspondence Address: BELL, BOYD & LLOYD, LLC, P. O. BOX 1135, CHICAGO, IL, 60690-1135, US

(21) Appl. No.: 10/503,772

(22) PCT Filed: Feb. 3, 2003
(86) PCT No.: PCT/DE03/00301

(30) Foreign Application Priority Data
Feb. 6, 2002 (DE) 102 04 887.8

(51) Int. Cl. H04B 1/034

(52) U.S. Cl. 455/575.8; 455/100

(57) ABSTRACT

The present invention relates to a holder for an electronic device, wherein the holder includes a receptacle that is specifically configured for the electronic device, a base device which includes an integrated electrical connection element, which is independent of the receptacle, for establishing an electrical connection between the electronic device and an electrical unit, and fixing parts for establishing a detachable mechanical connection between the base device and the receptacle.

### BACKGROUND OF THE INVENTION

The present invention relates to a holder for an electronic device, wherein the holder includes a receptacle that is configured specifically for the electronic device, and further includes a base device connected to the receptacle.

Holders configured specifically for electronic devices are known in the state of the art. For instance, German patent DE 198 50 044 C1 describes a mobile-phone holder for a vehicle which includes a base part for permanent fixing in the vehicle and a mobile-phone holder part that can be attached to the base part. The mobile phone is connected to the electrical supply of the vehicle and to the phone aerial of the vehicle via a connecting cable permanently connected to the mobile-phone holder part. This electrical connection to the vehicle supply and the aerial must be permanently installed; typically by suitable specialists, such as vehicle workshops or vehicle electricians. One disadvantage of the described mobile-phone holder for a vehicle is that if the vehicle owner wants to use a different type of mobile phone that no longer fits in the original mobile-phone holder part because of its different design, he/she must use a new mobile phone holder part. This again needs to be connected to the relevant vehicle electrical system by specialists, presenting difficulties when changing the mobile phone and the associated replacement of the holder. Parallel use of several different mobile phones is not possible in a vehicle if they do not fit in the same holder.

In addition, a two-piece holder for a mobile phone is known from Swedish patent application SE 98 02 106 A, which includes a “cradle” designed to fit the shape of the mobile phone, and a holder that can be fixed in a vehicle. The complete holder is assembled by fixing the cradle onto the holder. If the holder is fixed in the vehicle, then the mobile phone can be fixed in the vehicle by inserting it into the cradle. The system is adapted to suit different mobile phone models by replacing the cradle, while the holder can remain permanently fixed in the vehicle. The disadvantage of this solution is that additional cables are required to electrically connect the mobile phone to external units such as loudspeakers or aerials, and such cables are not located in fixed positions in the vehicle when the mobile phone is not in use. If the mobile phone is mounted in the holder and is meant to be connected to the external electrical units, one must first locate the relevant cable and then connect its associated connector to the mobile phone, which can be a time-consuming process due to the small size of typical plug-in connections.

Therefore, the present invention is directed toward a holder for an electronic device which enables an easy-to-establish electrical connection between the electronic device and an external electrical unit, wherein the holder easily adapts to suit different electronic devices.

### SUMMARY OF THE INVENTION

Accordingly, a holder for an electronic device is provided which includes,
a receptacle configured specifically for the electronic device;
a base device having an integrated electrical connection element, which is independent of the receptacle, for establishing an electrical connection between the electronic device and an electrical unit; and
fixing parts for establishing a detachable mechanical connection between the base device and the receptacle.

The use of receptacles configured specifically for an electronic device or a device product line results in it being possible to adapt the holder to suit different electronic devices or device product lines. Since the base device includes an electrical connection element that is independent of the receptacle and keeps its same position irrespective of the receptacle used, the electrical connection elements between the base device and an external electrical unit need not be changed when replacing the receptacle.

The electrical connection element being independent of the receptacle in this context, to the shape and position of the electrical connection element of the base device being independent of the position of the receptacle relative to the base device. As such, for example, upon removing the receptacle from the base device, the electrical connection element keeps its same shape and position.

The receptacle and base device may be mechanically connected using the fixing parts, after which the holder is in a ready-to-use condition. The fixing parts must ensure a durable connection between the receptacle and base device. This connection is reversible and always may be detached with comparative ease so that, when a different electronic device is used, a receptacle configured specifically therefore can be connected to the base device.

Thus, the holder according to the present invention combines the advantage of easy adaptability of the holder to suit different electronic devices with the additional advantage that, when using different receptacles, the electrical connection elements, located on/in the base device, for establishing electrical connections between the electronic device and external electrical units may remain the same.

An advantageous embodiment of the present invention is obtained when the fixing parts fix the electrical connection element in such a way that an electrical connection is made for the electronic device upon reaching a defined retaining position. The defined retaining position is, in general, the position in which the electronic device lies when it has been inserted in the holder and in which it is meant to remain for a certain time either for use or for safekeeping. In general, the electronic device is held in this position by special retaining elements such as clips, projections or catches. With respect to the holder according to the present invention, these retaining elements are mainly located on the specifically configured receptacle as they are generally adapted to suit the shape and function of the electronic device.

The above-described embodiment of the holder according to the present invention has the advantage that, upon inserting the device in the holder, no additional effort is needed in order to make the electrical connection. The electrical connection is automatically made when engaging the electronic device in the holder, thus avoiding, for example, plugging in a connector by hand and hence increasing the user-friendliness of the holder.

The fixing parts for establishing a detachable mechanical connection between the base device and the receptacle are preferably mechanical parts such as screws, catches, channels, keying or combinations thereof. For example, the receptacle and the base device can be designed in such a way that areas of the one device have a shape which is matched by a corresponding complementary shape of areas of the other device, whereby bringing together the receptacle and the base device creates a complimentary fit between these two parts which then connects them together. For example, the base device may have a T-shaped longitudinal shoulder facing a complementary-shaped channel formed in the receptacle. One or more catches or one or more screws, or a combination thereof, may be provided, for example, for additional fixing of the base device relative to the receptacle. In sum, all mechanical parts effecting such a fit between receptacle and base device are advantageously suitable as fixing parts. Besides mechanical fixing parts for establishing a detachable mechanical connection between the base device and the receptacle, fixing parts based on magnetic forces or other fixing parts such as Velcro-type fasteners, also may be used.

To make it easier to insert the electronic device in the holder as well as to fix the electronic device more robustly therein, it is advantageous if the receptacle, at least in part, has a complementary shape to the external shape of at least one area of the electronic device. By shaping in this way, a user of the receptacle sees, even before inserting the electronic device, its position in the receptacle, thereby making the electronic device easier and quicker to insert in the holder. In addition, this shaping to fit provides even better fixing of the electronic device in the defined retaining position, thereby resulting in a more robust holding mechanism for the electronic device that is less sensitive to vibrations.

The holder according to the present invention also may be used for holding smaller electronic devices. Since such devices, generally, also have correspondingly small control elements, it may be advantageous if the base device includes parts for operating the electronic device. This simplifies operation of the electronic device when it is located in the holder. When using different electronic devices with the same holder, the same operating parts on the base device may respectively control different functions of the different electronic devices in each case.

Adapting the holder of the present invention to different electronic devices is further simplified if the holder additionally includes an adapter for establishing the electrical connection between the electronic device and the electrical connection element. In the case of plug-in connections, this may be an adapter, for example, between a plug-type electrical connection element on the base device and the corresponding mating piece on the electronic device. In this case, for example, the adapter can be plugged directly onto the electrical connection element. In addition, it is possible to integrate the adapter in the receptacle, the adapter then having to be mounted on the receptacle in such a way that when the receptacle and base device are connected and the electronic device has been inserted in the holder, the adapter is in contact with the electrical connection element and the electronic device. This enables even greater flexibility in adapting the holder to suit different electronic devices. This embodiment enables the use of different electronic devices using the holder according to the present invention even when the different electronic devices are fitted with electrical connectors of different designs.

The holder according to the present invention is advantageously suited to connect an electronic device to external control equipment. For example, this may be a unit for controlling functions of the electronic device, or add-on devices connected to the control unit. Such control equipment may be computers, for example, which exchange data with the electronic device or compare data with data saved on the electronic device. In addition, the control equipment may be connected to external input and/or output modules for the electronic device, for example, and control the output of data such as characters, images and/or sounds, for instance.

The electrical unit that can be connected to the electronic device also may be a power supply unit which can be used to supply the electronic device with electrical power, for example, and/or, in the case of a battery operated device, to recharge the batteries.

The holder is advantageously suited to holding electronic devices that are data processing units or input and/or output modules of data processing units. Such data processing units may be organizers or personal digital assistants (PDSs), for example. Input and/or output modules of data processing units may be touch-screens, monitors or integral input/output devices for computers. In addition, the electronic device may include at least one part of a mobile telecommunications terminal device. For example, this may be the telecommunications terminal device itself, a part of a mobile telecommunications terminal device or a device that contains a mobile telecommunications module. In the context of this embodiment of the holder according to the present invention, it can be useful for the electrical unit which can be connected to the telecommunications device to contain an aerial unit.

Both the organizers and PDAs cited as well as the mobile telecommunications terminal devices are electronic devices which are nearly always carried with the user. Since these devices are often operated with batteries, a holder having an electrical connection for charging the batteries is quite advantageous. In addition, it is often necessary to compare data saved in the organizers, PDAs and mobile telecommunications terminal devices with data such as addresses, phone numbers, dates or to-do lists saved on external computers. This comparison also can be performed via the connection element mounted on the holder according to the present invention.

Today's extremely rapid innovation cycles of often just six months or a year for the aforementioned electronic devices require that devices need to be changed frequently in order to be able to work with state-of-the-art devices. In this situation it is not desirable, however, that the connections (often permanently installed) to the external electrical units be re-installed every time. Here, the holder according to the present invention has the advantage that it can be adapted to suit each new device without needing to change the electrical connection elements to external electrical units.

When the electronic device intended for the holder contains at least a part of a mobile telecommunications terminal device, it also may be advantageous that the holder includes a second electrical connection element for establishing an electrical connection between the electronic device and an aerial unit. For example, when using a telecommunications terminal device that has been inserted in the holder, the electrical connection element can establish a connection between the telecommunications terminal device and a power supply unit and/or a control unit for a loudspeaker, for example. The telecommunications terminal device can be coupled to an external aerial, for example, via the second electrical connection element. The telecommunications terminal device then may be coupled to an external aerial via the second electrical connection element, for example. This advantageously allows the use of loudspeakers installed in specific locations, as hands-free equipment in vehicles or in conference rooms, for example, and aerials.

To enable the base device to be fixed to a wall or to any object, the base device of the holder according to the present invention also includes parts for fixing to a support. This provides particular versatility for mounting the holder in the user's surroundings. By fixing the base device, the holder does not wobble or slip, for example, when inserting the electronic device, thereby increasing the user-friendliness of the holder. As such, for fixing the base device on the support, screws, adhesive, hooks, magnets or similar fixing parts may be used.

The holder according to the present invention advantageously may be used in a vehicle, the aforementioned support then being a component of the vehicle. With vehicles, one has the particular problem that when kept in the vehicle, electronic devices are meant to be connected to external electrical units such as power supply units (for charging the batteries), aerials (for reducing the electromagnetic radiation to the head of the user) or control units (hands-free equipment, which may be connected to a car radio (muting)). On leaving the vehicle, however, it must be possible for the user to easily take the electronic device with him/her. In the same way, on getting into the vehicle it should be possible to insert the electronic device easily into the holder, substantially in one movement, while simultaneously making contact with the external electrical units. The holder according to the present invention is suitable for use in a vehicle because the holder can be adapted to different electronic devices without changing the electrical connection elements located in and on the base device; thus, the electrical section of the holder so to speak, can remain permanently in the vehicle.

The present invention additionally includes a receptacle for fixing an electronic device to a base device having an electrical connection element, which is independent of the receptacle, for establishing an electrical connection between the electronic device and an electrical unit. The receptacle:
is configured specifically for the electronic device;
include fixing parts for establishing a detachable mechanical connection to a base device; and
include a recess for the electrical connection element.

Such a receptacle has the same advantages as the holder described above. It enables retention of an electronic device while simultaneously connecting the electronic device to an electrical unit. In order to retain the device, the receptacle is connected to a base device which can be used with a multiplicity of different receptacles and, hence, with a multiplicity of electronic devices.

The described receptacle also solves the aforementioned problem. The receptacle is designed so that an electrical connection between electronic device and the electrical unit can be established by the electrical connection element located on the base device. Since the mechanical connection between the receptacle designed to suit the electronic device and the base device is detachable, when replacing the electronic device a receptacle designed to suit the new device can be mounted on the base device without needing to replace the electrical connection parts. The recess made in the receptacle for the electrical connection element ensures that the electronic device has access to the electrical connection element. Thus, the described receptacle also enables easy adaptation of a holder to suit different electronic devices.

The receptacle, the electronic device, the base device and the fixing parts also may be advantageously designed as described in the above text.

The present invention additionally includes a base device for an electronic device, which include:
an electrical connection element for establishing an electrical connection between the electronic device and an electrical unit; and
fixing parts for establishing a detachable mechanical connection between the base device and a receptacle configured specifically for the electronic device, wherein the electrical connection element is independent of the receptacle.

The base device according to the present invention can be connected to various receptacles configured specifically for different electronic devices, and therefore may be adapted easily to suit different electronic devices. An electrical connection between the electronic device and the electrical unit can be established via the electrical connection element mounted on the base device. Since the electrical connection element is independent of the receptacle, when changing the electronic device, the receptacles configured specifically for the device in question can be replaced without requiring time-consuming replacement of the electrical connection elements. Thus, this base device also solves the aforementioned problem.

Also in this case, the base device, electrical connection element, fixing parts and receptacle also may be advantageously designed as described in the above text.

Additional features and advantages of the present invention are described in, and will be apparent from, the following Detailed Description of the Invention and the Figures.

### BRIEF DESCRIPTION OF THE FIGURES

FIG. 1 shows the modular construction of the vehicle holder according to the present invention for a mobile communications terminal device.

FIG. 2 shows the detailed rear view of the receptacle according to the present invention of the vehicle holder shown in FIG. 1.

FIG. 3 shows the receptacle shown in FIG. 2 with an aerial adapter cable additionally attached.

FIG. 4 shows the assembled vehicle holder shown as separate modules in FIG. 1.

FIG. 5 shows the rear view of the assembled vehicle holder shown as separate modules in FIG. 1.

### DETAILED DESCRIPTION OF THE INVENTION

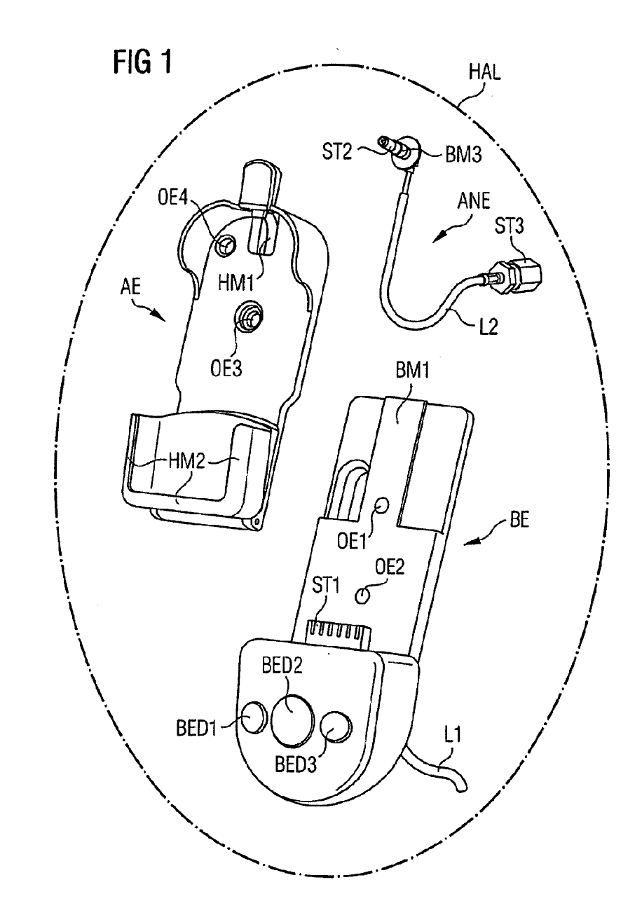

FIG. 1 shows the individual modules of a holder HAL according to the present invention for holding a mobile phone in a vehicle, where the receptacle AE is provided for holding the mobile phone which is held in the intended retaining position by a clip HM1 and projections HM2. The receptacle may be fixed to a base device BE by a screw through a hole OE3, for example. A hole OE4 is used to take an external aerial connector that may be fixed in the hole OE4 using a latch BM3.

The aerial connector ST2 is part of an aerial adapter cable ANE also shown in FIG. 1 with which the mobile phone can be connected to the aerial unit of the vehicle via the connector ST2, a lead L2 and another connector ST3.

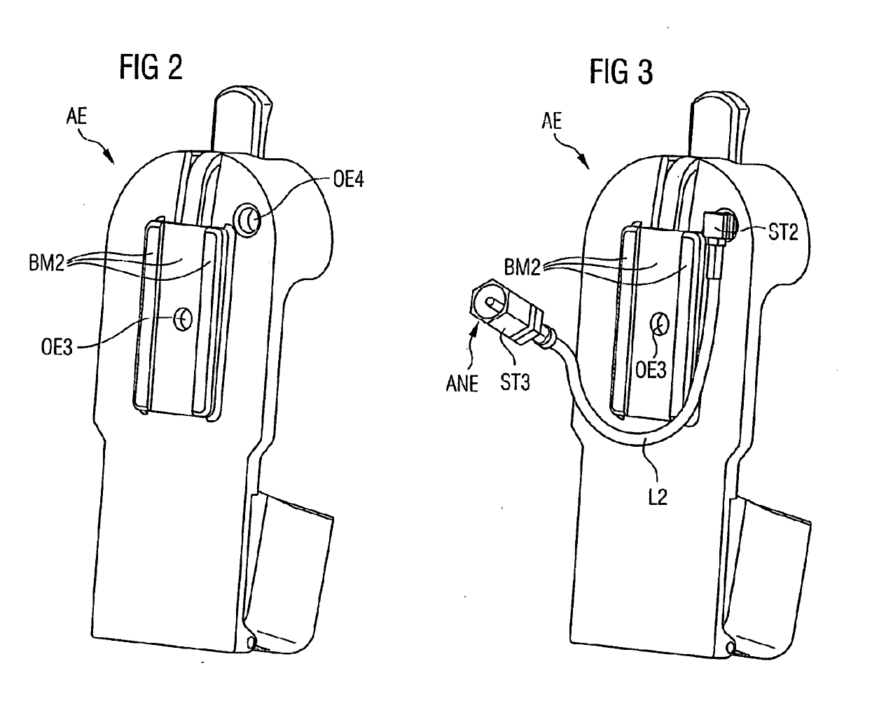

The associated base device BE is also shown in FIG. 1. This includes a connector ST1 as an integrated electrical connection element, with which the mobile phone can be connected via a line L1 to an external vehicle module and/or a power supply unit. In addition, the base device BE includes control elements BED1, BED2, BED3. The central control element BED2 can be used to accept an incoming call. The control elements BED 1 and BED3, respectively, may be used to adjust the volume of the external hands-free unit of the mobile phone. The base device BE may be fixed in the vehicle as support using two screws through holes OE1 and OE2, for example. The base device BE may be connected to the receptacle AE by a T-shaped longitudinal shoulder BM1 and a complementary-shaped channel BM2 formed in the receptacle (see FIGS. 2 and 3).

FIG. 2 shows a rear view of the receptacle AE shown in FIG. 1. Besides the holes OE3, OE4 for fixing the receptacle AE to the base device BE and for taking the aerial connector ST2, the diagram shows a channel BM2 for receiving the shoulder BM1 of the base device BE (see FIG. 1). If the receptacle AE is to be connected to the base device BE, the channel BM2 of the receptacle AE is pushed over the shoulder BM1 (see FIG. 1) of the base device thereby mechanically fixing the receptacle AE to the base device BE. The shoulder BM1 and the channel BM2 are designed in this case so that the mechanical connection that they make is sufficient during normal use of the holder HAL according to the present invention to fix base device BE and receptacle AE relative to each other. If the receptacle AE is also to be secured to the base device BE, this can be achieved by using a retaining screw through the hole OE3.

Like FIG. 2, FIG. 3 shows the rear view of the receptacle AE. In this case, the connector ST2 of the aerial adapter ANE is inserted in the appropriate hole OE4 (see FIG. 2) and held in position via the latch BM3 (see FIG. 1).

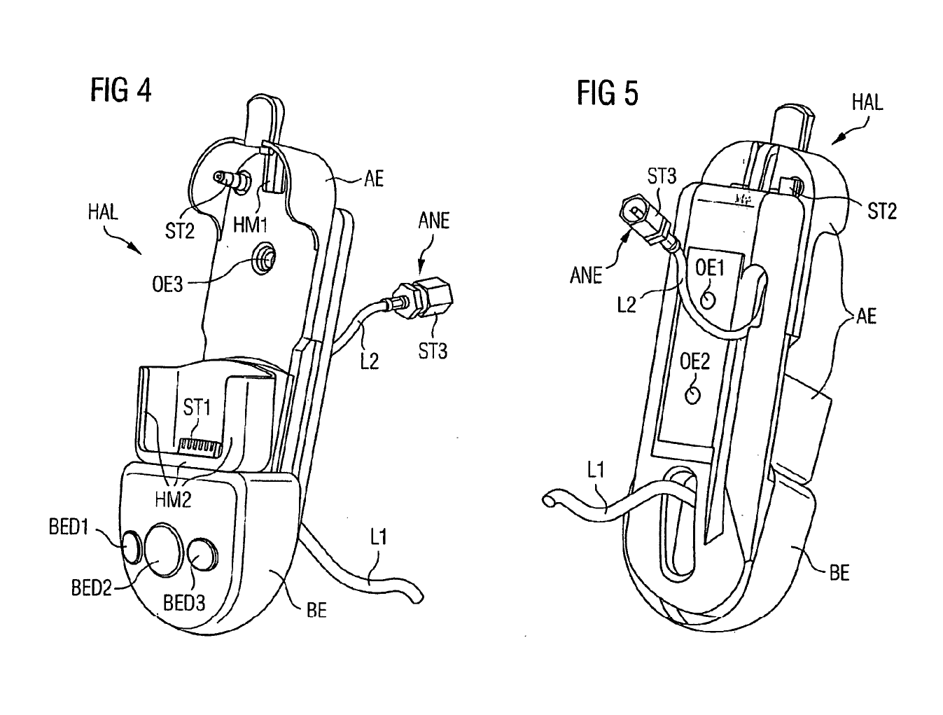

FIGS. 4 and 5 show the assembled holder HAL according to the present invention in the front and rear view. In FIG. 4 the connector ST1 of the base device BE is visible projecting through a suitable hole in the receptacle AE. When inserting the mobile phone in the holder HAL, the phone is first inserted behind the projections HM2, and the mating connector, located on the underside of the mobile phone, is pushed onto the connector ST1. Then the mobile phone is pressed backwards into the clip HM1, automatically connecting the aerial output socket on the underside of the mobile phone to the aerial connector. Thereafter, the mobile phone is automatically connected via the aerial adapter ANE, the associated connector ST3 and the lead L1 to the in-car aerial and vehicle module in the car.

If the mobile phone is to be removed from the holder HAL, one proceeds in the reverse order from that described above.

If a different mobile phone is to be used in the same vehicle, the receptacle AE is pushed down from the base device BE, if necessary after unscrewing the retaining screw through the hole OE3, and the aerial connector ST2 is disconnected. Then, a receptacle AE matching the new mobile phone is selected, the aerial connector ST2 is inserted in the hole OE4 suitably provided in the new receptacle AE, and the new receptacle AE with the channel BM2 is pushed onto the shoulder BM1 of the base device. The holder HAL converted in this way then may be used immediately with the new mobile phone without needing to change the relevant equipment installed in the vehicle. If the connectors in the old and new mobile phone have different designs, an adapter may need to be attached to one of the connectors ST1 or ST2 or both. This adapter either may be a separate part or may be connected to the new receptacle AE. Regardless of this, one still has the advantage that the electrical installation on base device BE and vehicle can remain unchanged when replacing the mobile phone.

The present invention describes a holder for an electronic device, plus a receptacle configured specifically for the electronic device, and a base device which includes an integrated electrical connection element, which is independent of the receptacle, for establishing an electrical connection between the electronic device and an external electrical unit. Fixing parts may be used to fix the receptacle to the base device, resulting in a holder that can be adapted easily to suit different electronic devices without needing to change electrical connection elements mounted in and on the base device. The described holder, receptacle and base device are based on the fundamental modular design in which the parts of the holder (modules) that need to be adapted for mechanical fixing to the electronic device are independent of those that enable an electrical connection to be established between the electronic device and an external electrical unit.

Although the present invention has been described with reference to specific embodiments, those of skill in the art will recognize that changes may be made thereto without departing from the spirit and scope of the present invention as set forth in the hereafter appended claims.

1-16. (canceled)

17. A holder for an electronic device, wherein the electronic device includes an electrical connection element, the holder comprising:
a receptacle specifically configured for the electronic device;
a base device, wherein the base device includes an integrated electrical connection element, independent of the receptacle, for direct connection to the electrical connection element of the electronic device for establishing an electrical connection between the electronic device and an electrical unit; and
fixing parts for establishing a detachable mechanical connection between the base device and the receptacle.

18. A holder for an electronic device as claimed in claim 17, wherein the fixing parts fix the electrical connection element of the base device in such a position that an electrical connection is established for the electronic device upon the electronic device reaching a defined retaining position in the holder.

19. A holder for an electronic device as claimed in claim 17, wherein the receptacle includes, at least in part, a complimentary shape to an external shape of at least a part of the electronic device.

20. A holder for an electronic device as claimed in claim 17, wherein the base device includes parts for operating the electronic device.

21. A holder for an electronic device as claimed in claim 17, further comprising an adapter for establishing the electrical connection between the electronic device and the electrical unit, wherein the adapter is disposed between the electronic device and the electrical connection element of the base device.

22. A holder for an electronic device as claimed in claim 17, wherein the electrical unit includes a control unit.

23. A holder for an electronic device as claimed in claim 17, wherein the electrical unit includes a power supply unit.

24. A holder for an electronic device as claimed in claim 17, wherein the electronic device is at least one of a data processing unit, an input module of a data processing unit, an output module of a data processing unit, and an input/output module of a data processing unit.

25. A holder for an electronic device as claimed in claim 17, wherein the electronic device includes at least part of a mobile telecommunications terminal device.

26. A holder for an electronic device as claimed in claim 25, wherein the electrical unit includes an aerial unit.

27. A holder for an electronic device as claimed in claim 26, further comprising a second electrical connection element for establishing an electrical connection between the electronic device and the aerial unit.

28. A holder for an electronic device as claimed in claim 17, wherein the base device includes parts for fixing to a support.

29. A holder for an electronic device as claimed in claim 28, wherein the support is part of a vehicle.

30. A receptacle for fixing an electronic device to a base device, wherein the electronic device includes an electrical connection element, and the base device includes an integrated electrical connection element independent of the receptacle for direct connection to the electrical connection element of the electronic device for establishing an electrical connection between the electronic device and an electrical unit, the receptacle comprising:
fixing parts for establishing a detachable mechanical connection to the base device; and
a recess portion for accepting the electrical connection element of the base device, wherein the receptacle is specifically configured for the electronic device.

31. A base device for an electronic device, wherein the electronic device includes an electrical connection element, the base device comprising:
an integrated electrical connection element for direct connection to the electrical connection element of the electronic device for establishing an electrical connection between the electronic device and an electrical unit; and
fixing parts for establishing a detachable mechanical connection between the base device and a receptacle specifically configured for the electronic device, wherein the electrical connection element of the base device is independent of the receptacle.
